(19) United States
(12) Patent Application Publication
(10) Pub. No.: US 2007/0263711 A1
(43) Pub. Date: Nov. 15, 2007

(54) Operating DSL subscriber lines

(76) Inventors: Gerhard Guenter Theodor Kramer, Chatham, NJ (US); Carl Jeremy Nuzman, Union, NJ (US); Philip Alfred Whiting, New Providence, NJ (US); Miroslav Zivkovic, The Hague (NL)

Correspondence Address: Lucent Technologies, Inc.;Docket Administrator - Room 3J-219, 101 Crawfords Corner Road, Holmdel, NJ, 07733-3030, US

(21) Appl. No.: 11/796,366

(22) Filed: Apr. 26, 2007

Related U.S. Application Data
(60) Provisional application No. 60/795,369, filed on Apr. 26, 2006.

(51) Int. Cl. H04L 5/16

(52) U.S. Cl. 375/222

(57) ABSTRACT

An apparatus includes a plurality of DSL modems. Each DSL modem is configured to be connected to a corresponding DSL subscriber line. A first of the DSL modems is configured to transmit a data stream to a DSL subscriber via inter-line cross-talk between the one of the DSL subscriber lines connected to the first of the DSL modems and the one of the DSL subscriber lines connected to a second of the DSL modems.

This application claims the benefit of U.S. provisional application No. 60/795,369 filed on Apr. 26, 2006 by Gerhard G. Kramer, Carl J. Nuzman, Philip A. Whiting, and Miroslav Zivkovic.

### BACKGROUND

1. Field of the Invention

The invention relates to digital DSL subscriber line systems.

2. Discussion of the Related Art

This section introduces aspects that may be helpful to facilitating a better understanding of the inventions. Accordingly, the statements of this section are to be read in this light and are not to be understood as admissions about what is in the prior art or what is not in the prior art.

For some time, the plain old telephone system (POTS) has been used to transmit both voice and data communications. In the POTS, digital DSL subscriber lines (DSL) systems have become popular ways of communicating data over POTS wires. In a DSL system, the local central office and the DSL subscriber are connected by a telephone DSL subscriber line, e.g., a local loop. Both the local central office and the DSL subscriber have a modem connected to transmit and receive data over the telephone DSL subscriber line.

DSL communications are typically regulated by DSL standards. The various DSL standards may regulate the conditions of the communications over individual DSL subscriber lines. In particular, the DSL standards regulations can limit bandwidths and/or communication powers on the channels used to carry DSL communications. These regulations effectively place physical limits on obtainable information transmission rates during DSL communications.

On a telephone line, communications can produce cross-talk on physically near-by telephone lines, i.e., twisted wire pairs. Such cross-talk can also limit the transmission rates that can be obtained during DSL communications. For that reason, vector-signaling techniques have been promoted. Vector-signaling techniques may provide a way for increasing downstream and/or upstream information transmission rates in the presence of such cross-talk.

In typical forms, vector signaling involves measuring the cross-talk between different telephone DSL subscriber lines and then, preceding DSL communications in a manner that compensates for the cross-talk. In such techniques, detailed amplitude and phase measurements of the DSL channel matrix may be needed to effectively compensate for such cross-talk. Vector signaling techniques may obtain information transmission rates that are even higher than those obtainable in the absence of inter-line cross-talk.

### BRIEF SUMMARY

Typically, the cross-talk between the twisted wire pairs of the plain old telephone system (POTS) is considered as interference in a telephone communication system. Herein, some embodiments use such cross-talk advantageously to carry some data between telephone company nodes and DSL subscribers.

A first embodiment features an apparatus that includes a plurality of DSL modems. Each DSL modem is configured to be connected to a corresponding DSL subscriber line. A first of the DSL modems is configured to transmit a data stream to a DSL subscriber via inter-line cross-talk between the one of the DSL subscriber lines connected to the first of the DSL modems and the one of the DSL subscriber lines connected to a second of the DSL modems.

A second embodiment features a method of transmitting data from telephone company (TELCO) DSL modems to a set of DSL subscribers. The method includes transmitting data from a first of the DSL modems to one of the DSL subscribers via a DSL subscriber line connected to a second of the DSL modems.

A third embodiment features a method for operating a set of DSL subscriber lines. The method includes updating entries of a power transmission matrix for the set of DSL subscriber lines such that a total utility of the set of DSL subscriber lines has a larger value when the per-tone transmission powers of the DSL subscriber lines have the determined values.

### BRIEF DESCRIPTION OF THE DRAWINGS

FIG. 1 is a block diagram illustrating a portion of a plain old telephone system (POTS) that supports an embodiment of a digital DSL subscriber line (DSL) system;

FIG. 2 is a block diagram illustrating a portion of a POTS that supports another embodiment a DSL system; and

FIG. 3 is flow chart illustrating one method for transmitting data in a DSL system that is based on a helper line, e.g., in the DSL systems of FIGS. 1-2;

FIG. 4 is a flow chart illustrating a method for transmitting data to a set of DSL subscribers, e.g., via the DSL system of FIG. 1;

FIG. 5 is a flow chart illustrating a method imposes the constraints explicitly during approximate maximizations of objective functions in DSL systems;

FIG. 6 illustrates the action on a ½ line of a projection operation that may be used in some embodiments of the method of FIG. 5;

FIGS. 7-8 are flow charts illustrating a method that uses hat approximants to perform approximate constrained maximizations of objective functions in DSL systems;

FIGS. 9A and 9B illustrate simple hat approximants of respective convex-up and concave-up functions; and

FIG. 10 is a block diagram illustrating a controller that may be used to perform one or more of the methods of FIGS. 3, 4, 5, 7, and/or 8, e.g., in the local TELCO nodes of FIGS. 1 and 2.

In the Figures and text, like reference numerals indicate elements with similar functions.

In the Figures, the relative dimensions of some features may be exaggerated to more clearly show one or more of the structures being illustrated.

Herein, various embodiments are described more fully by the Figures and the Detailed Description of Illustrative Embodiments. Nevertheless, the inventions may be embodied in various forms and are not limited to the embodiments described in the Figures and Detailed Description of Illustrative Embodiments.

The inventions are intended to include data storage media encoded with machine-executable programs of instructions for performing processor-executable steps of the various methods described in this specification.

### DETAILED DESCRIPTION OF ILLUSTRATIVE EMBODIMENTS

A) DSL Communications Assisted by Cross-talk

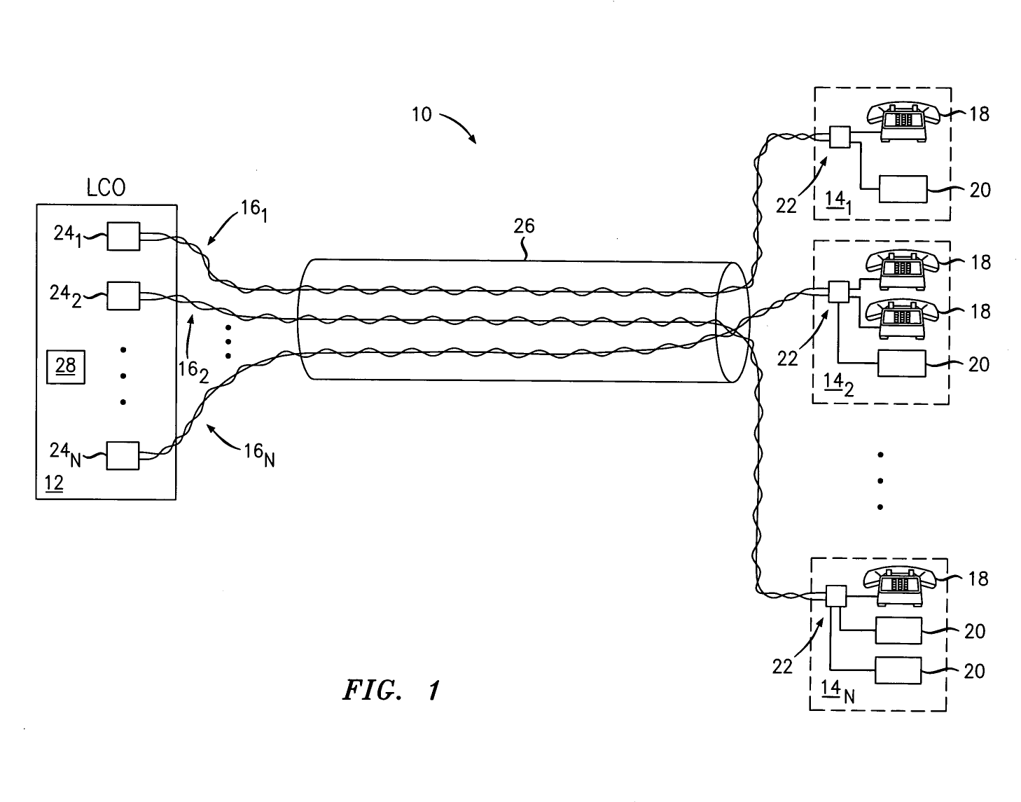

FIG. 1 shows a portion 10 of a POTS that supports communications between a local telephone company (TELCO) node 12, e.g., a local central office, and a plurality of local DSL subscribers 14₁, 14₂, . . . , 14_{N} The portion 10 of the POTS supports data and voice communications on DSL subscriber lines 16₁, 16₂, . . . 16_{N}, which physically connect the local TELCO node 12 to the individual local DSL subscribers 14₁-14_{N}. The set of local DSL subscribers 14₁-14_{N} may include private residences and/or enterprises. Each local DSL subscriber 14₁-14_{N} may have one or more telephones 18 and may also have one or more DSL subscriber modems 20. The DSL subscriber's telephone(s) 18 and DSL modem(s) 20 connect to the DSL subscriber lines 16₁, 16₂, . . . 16_{N} of the TELCO via local wiring 22.

The portion 10 of the POTS also supports DSL communications on some or all of the DSL subscriber lines. Each DSL subscriber line 16₁-16_{N} includes is formed by a series of one or more twisted copper wire pairs as illustrated in FIG. 1. Each DSL subscriber line 16₁-16_{N} physically connects a corresponding DSL modem 24₁, 24₂, . . . 24_{N} of the TELCO node 12 to the one or more modems 20 at a corresponding local DSL subscriber 14₁-14_{N}. That is, each DSL subscriber line connects one TELCO DSL modem to a corresponding DSL subscriber. In operation, each of the shown DSL subscriber lines 16₁-16_{N} is configured to support data communications between the corresponding DSL modem of the TELCO node 12 and the one or more modems of the corresponding local DSL subscriber 14₁-14_{N}.

Herein, a DSL subscriber line refers to the twisted wire pair that physically connects the DSL modem of a TELCO node to the DSL modem of a DSL subscriber. Even if the path between the TELCO node and the DSL subscriber includes additional wiring to connect the DSL modem(s) at the DSL subscriber and/or at the TELCO node, the DSL subscriber line will be referred to as physically connecting these two DSL modems.

In the DSL subscriber lines 16₁-16_{N}, the segments of the twisted copper wire pairs are located within one or more cables 26. Examples of such cables 26 are structures referred to as binders by those of skill in the art. In particular, each cable 26 typically holds a large number of such twisted copper wire pairs in close physical proximity. The close physical proximity of twisted copper wire pairs in the one or more cables 26 can lead to inductive cross-talk between different ones of the twisted copper wire pairs of the DSL subscriber lines 16₁-16_{M}. Such inter-DSL subscriber line cross-talk may also be caused by other physical conditions. Typically, the equipment of a POTS system is designed to minimize such cross-talk, because the cross-talk can interfere with communications.

In contrast, various embodiments use such cross-talk to transmit data from the TELCO node 12 to the individual DSL subscribers 14₁-14_{N}. In particular, the local TELCO node 12 includes a controller 28 that can transmit part of a data stream to a targeted one of the DSL subscribers 14₁-14_{N} from one of the TELCO DSL modems 24₁-24_{N} that is not directly physically connected to the DSL subscriber line 16₁-16_{N} that physically connects to the one of the DSL subscribers 14₁-14_{N}. That is, the controller 28 sends that part of the data stream to another of the TELCO DSL modems 24₁-24_{N}, and the another of the TELCO DSL modems 24₁-24_{N} then, transmits that part of the data stream. Even though that the another of the TELCO DSL modems 24₁-24_{N} modem 24₁-24_{N} is not directly physically connected to the targeted one of the DSL subscribers 14₁-14_{N}, the cross-talk coupling in the cable 26 causes the transmitted data to be transferred to the DSL subscriber line corresponding to the targeted one of the DSL subscribers 14₁-14_{N}. Thus, the targeted one of the DSL subscribers 14₁-14_{N} receives the data on its own DSL subscriber line 16₁-16_{N}.

In various embodiments, the controller 28 of the TELCO node 12 separates a data stream into first and second parts. The controller 28 causes the first part of the data stream to be transmitted to a target DSL subscriber 14₁-14_{N} via the central office modem DSL subscribers 24₁-24_{N} corresponding to the target DSL subscriber 14₁-14_{N} and causes the second part of the data stream to be transmitted to the target DSL subscriber 14₁-14_{N} by another one of the central office modems and inter-DSL subscriber line cross-talk as described above.

In the embodiments of FIG. 1, the first and second parts of the data stream are sequences of independent data. For that reason, the local TELCO node 12 may not need to significantly time or phase synchronize data transmissions to a target one of the DSL subscribers 14₁-14_{N} via different ones of two such TELCO DSL modems 24₁-24_{N}. Some embodiments may however, perform some synchronization between the two DLS modems 24₁-24_{N} that send data to the same DSL subscriber 14₁-14_{N}. For example, in an orthogonal frequency division modulation (OFDM) based DSL system, one of the two DSL modems 24₁-24_{N} may be synchronized so that its symbol periods lie in the cyclic extensions of the symbols of the other of the two modems 24₁-24_{N}.

In some embodiments of the above-described DSL system, the first and second parts of the data stream may be transmitted in different DSL frequency bands. Then, the first and second parts of the data stream may be, e.g., separately processed in the modem 20 of the target DSL subscriber 14₁-14_{N}. Indeed, some standards enable DSL transmissions of data to be made in separate frequency bands.

In some embodiments of the above-described DSL systems, the first and second parts of the data stream may be transmitted in same DSL frequency band. The two parts may be, e.g., transmitted with very different power levels. Then, the receiving DSL subscriber modem 20 may decode one of the parts of the data stream, e.g., the part having a high power, and subtract out the decoded part from the received data stream to recover the remaining part of the data stream, e.g., the lower power data stream, which can then be separately decoded.

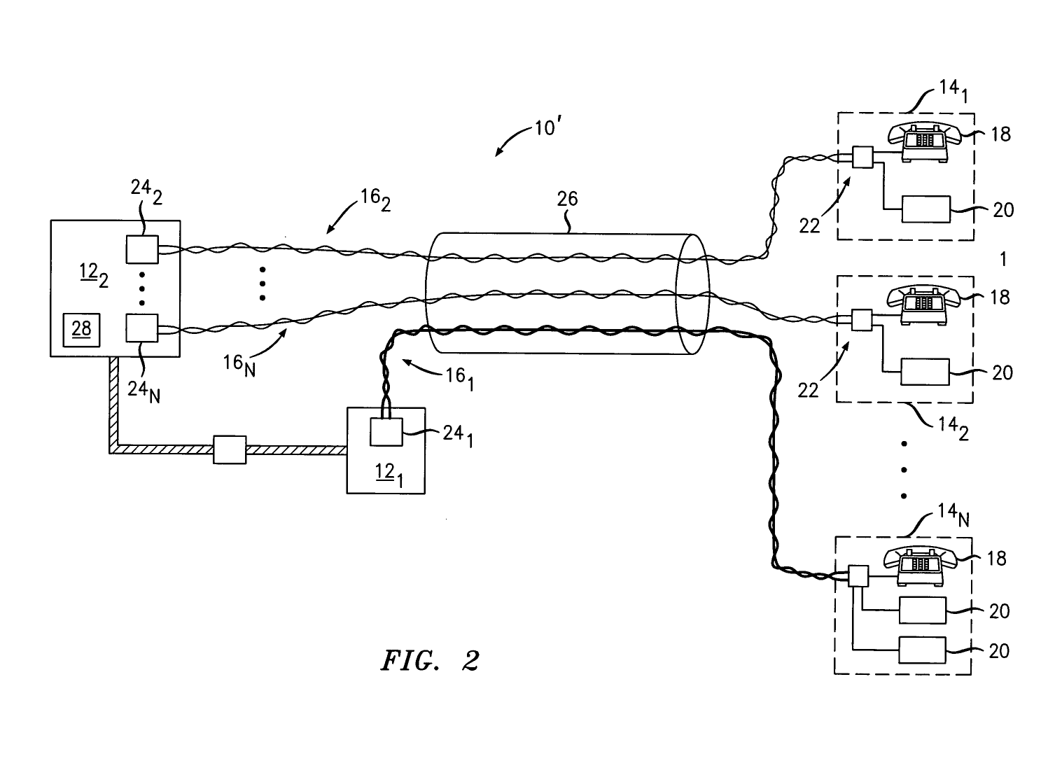

FIG. 2 shows a portion 10′ of another POTS that supports voice and data communications between DSL subscribers 14₁-14_{N} and two local TELCO nodes 12₁, 12₂. The local TELCO nodes 12₁, 12₂ are in different physical locations and may be either two LCOs or one LCO and one remote terminal (RT). The portion 10′ of the POTS 10′ includes DSL subscriber lines 16₁-16_{N}. The DSL subscriber lines 16₁-16_{N} directly connect the local TELCO nodes 12₁-12₂ to the individual local DSL subscribers 14₁-14_{N}. Each DSL subscriber line 16₁-16_{N} includes a sequence of one or more copper twisted wire pairs that connects one of the TELCO DSL modems 24₁, 24₂, . . . , 24_{N} to one or more DSL modems 20 at a corresponding one of the local DSL subscribers 14₁-14_{N}. At least, one of the TELCO DSL modems 24₁ is located in a different one of the TELCO nodes 12₁ than another one of the TELCO DSL modems 24₂-24_{N}.

Segments of some of the DSL subscriber lines 16₁-16_{N} that connect the two local TELCO nodes 12₁, 12₂ to the DSL subscribers 14₁-14_{N} are located within the same cable 26. For that reason, there is cross-talk between the DSL subscriber lines 16₁-16_{N} connecting the TELCO nodes 12₁, 12₂ and some or all of the DSL subscribers 14₁-14_{N}.

Again, various embodiments use such cross-talk between DSL subscriber lines 16₁-16_{N} to transmit data from the one or more of the TELCO nodes 12₁, 12₂ to one or more of the DSL subscribers 14₁-14_{N}. In particular, the POTS includes a controller 28 that connects to and controls the DSL modems in both TELCO nodes 12₁, 12₂. The controller 28 may, e.g., cause a data stream destined for a single target DSL subscriber 14₂ to be separated into first and second disjoint parts. Then, the controller 28 causes, e.g., the first part to be transmitted to the target DSL subscriber 14₂ from the TELCO DSL modem 24₁ of the first local TELCO node 12₁ and causes the second part to be transmitted to the target DSL subscriber 14₂ from one or more of the TELCO DSL modems 24₂-24_{N} of the second local TELCO node 12₂.

In the embodiments of FIG. 2, the first and second parts of the data are sequences of independent data sequences. For that reason, the local TELCO nodes 12₁, 12₂ may not need to time or phase synchronize the data transmissions to the target one of the DSL subscribers 14₁-14_{N} via the different TELCO DSL modems 24₁-24_{N}. Nevertheless, the two TELCO DSL modems 24₁-24_{N} may perform some amount of such synchronization in some embodiments.

In some such embodiments, the first and second parts of the data stream may be transmitted in different DSL frequency bands. Then, the first and second parts of the data stream may be separately processed in the DSL modem 20 of the target DSL subscriber 14₂.

In some of other embodiments, the first and second parts of the data stream may be transmitted in same DSL frequency band. The two parts may be, e.g., transmitted with very different power levels. Then, the receiving modem 20 may decode one of the parts of the data stream, e.g., the part having a high power, and subtract out the decoded part from the received data stream to recover the remaining part, e.g., the lower power data stream, which can then be separately decoded.

Various embodiments of the DSL systems of FIGS. 1 and 2 may enable more flexible distribution of data to target DSL subscribers 14₁-14_{N} via the physical DSL subscriber lines. For example, data may be re-distributed to distributing among TELCO DSL modems that are less busy. Such redistribution may enable these DSL systems to provide increased information transmission rates to some DSL subscribers 14₁-14_{N}.

Various embodiments of the DSL systems of FIGS. 1 and 2 may support DSL data communications under conditions that effectively exceed power and/or data rate limitations on DSL transmissions, e.g., upper power or data rate limitations that are imposed by DSL standards. Such limitations may be “effectively” circumvented by using inductive cross-talk between DSL subscriber lines to carry transmitted data.

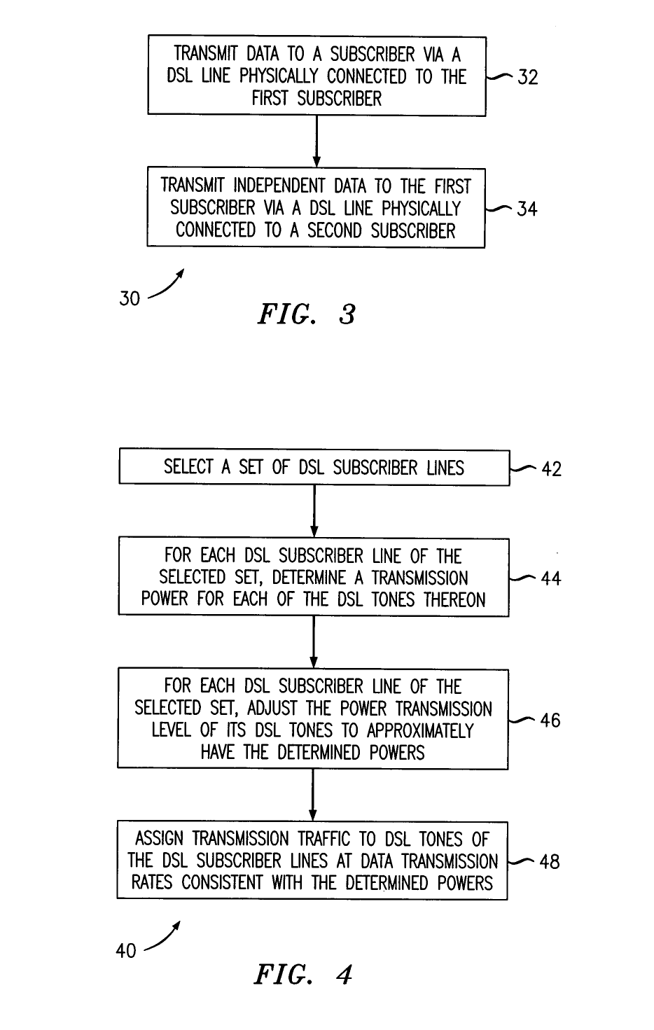

FIG. 3 illustrates a method 30 of transmitting data to DSL subscribers over DSL subscriber lines, e.g., in the portions 10, 10′ of the POTS of FIGS. 1 and 2. The method 30 includes transmitting data from a TELCO node to a first of the DSL subscribers via a DSL subscriber line connecting the first of the DSL subscribers (step 32). The method 30 includes transmitting independent data from a TELCO node to the first of the DSL subscribers via a DSL subscriber line directly connected to a second of the DSL subscribers (step 34).

The step 34 of transmitting independent data from a TELCO node to the first of the DSL subscribers via a DSL subscriber line directly connected to a second of the DSL subscribers may also include transmitting the independent data over part of the DSL subscriber line physically connected to the first of the DSL subscribers. For example, the step 34 may include transmitting the data between the second of the DSL subscriber lines and the first of the DSL subscriber lines via inductive inter-line cross-talk there between.

In some of the embodiments, the step 32 of transmitting data involves transmitting the data on a different frequency band than the step 34 of transmitting independent data.

In other embodiments, the step 32 of transmitting data involves transmitting the data on the same frequency band as the step 34 of transmitting independent data.

The transmitting step 32 may include transmitting the data over part of another of the DSL subscriber lines, wherein the other of the DSL subscriber lines is physically connected to the first of the DSL subscribers, e.g., DSL subscriber 14₁ in FIGS. 1-2. The transmitting step 32 may include transmitting the data from the one of the DSL subscriber lines to the another of the DSL subscriber lines via inductive inter-line cross-talk. The method 32 typically also includes transmitting data to the first of the DSL subscribers via a TELCO DSL modem conductively connected to the another of the DSL subscriber lines (step 34). In some embodiments, the steps 34 of transmitting data to a first one of the DSL subscribers via one of the DSL subscriber lines transmits the data on a different frequency band than the step 32 of transmitting data to the first one of the DSL subscribers via the another of the DSL subscriber lines.

B) Optimizing Tone-Power Levels on Individual DSL Subscriber Lines

On a single DSL subscriber line, the obtainable information transmission rate on a DSL tone usually increases with the per-tone transmission power. Thus, to increase transmission rates, it may be desirable to increase powers transmitted over DSL tones. On the other hand, DSL standards often put upper bounds on per-tone and per-line transmission powers in DSL systems. Furthermore, increasing the power transmitted on the DSL tones of one DSL subscriber line often increases interference levels on other DSL subscriber lines. For that reason, it is desirable to set per-tone and per-line transmission powers for a set of DSL subscriber lines together as a group rather than individually or in a per-line manner.

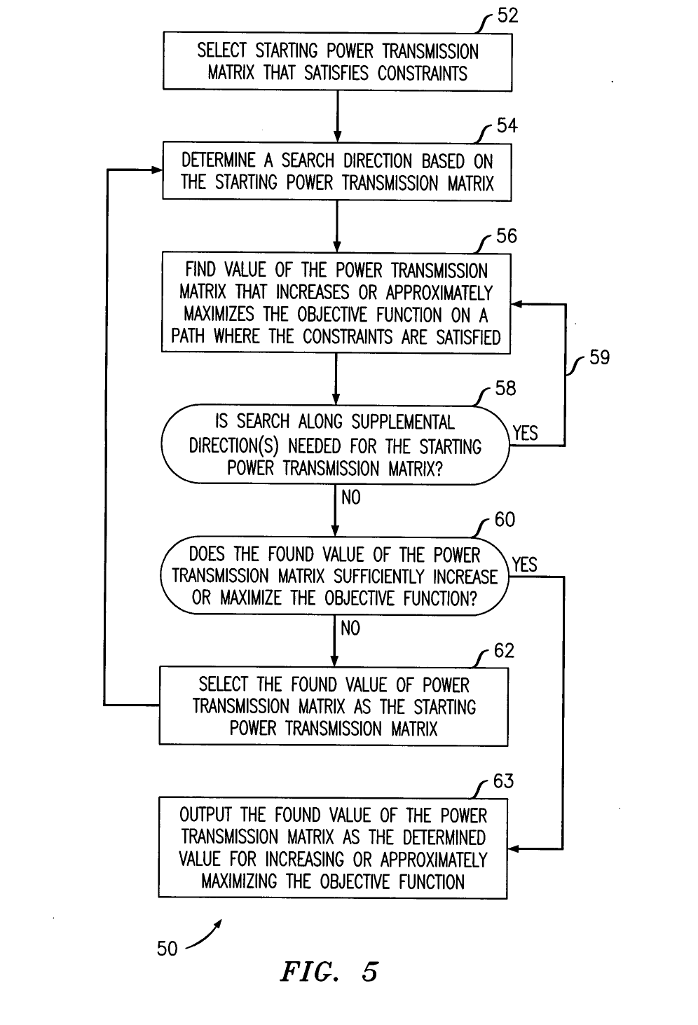

FIG. 4 illustrates a method 40 for transmitting data to a selected set of DSL subscribers. The method 40 may be performed by the local TELCO nodes 12, 12₁, 12₂ of FIGS. 1 and 2 and may also be performed by other DSL-enabled TELCO nodes that are not configured to use cross-talk between DSL subscriber lines to carry data to the DSL subscribers.

The method 40 includes selecting a set of N DSL subscriber lines on which the transmission power levels of DSL tones will be updated (step 42). For each DSL subscriber line of the selected set, the method 40 includes determining a transmission power for each of the F DSL tones thereon (step 44). In particular, the determinations set either maximum or average power transmission levels on the DSL tones that are used to carry data to the DSL subscriber lines of the set. The determined DSL transmission powers may vary with both the DSL tone and the DSL subscriber line. Thus, at the step 44, the determinations involve finding DSL transmission powers for each of the F DSL tones supported on each DSL subscriber line of the selected set. Thus, the step 44 involves determining a DSL power transmission matrix, P, as will be described below. For each DSL subscriber line of the selected set, the method 40 includes adjusting the power transmission levels of its F DSL tones to approximately have the values of the power transmission matrix, P, determined at the step 44 (step 46). The method 40 also includes assigning transmission traffic to DSL tones of the DSL subscriber lines in the selected set at data transmission rates consistent with the values of the elements of the power transmission matrix, P, as determined at above step 44 (step 48). At the step 48, data traffic may be, e.g., assigned to the DSL tones of the individual DSL subscriber lines in accordance with upper bounds on obtainable information transmission rates, e.g., as fixed by the determined power transmission matrix, P. Examples of such upper bounds are given by the matrix, R, as described in below eq. (2).

The method 40 may be performed by one or more of the local TELCO nodes 12, 12₁, 12₂ of FIGS. 1-2. In particular, one or more of the local TELCO nodes 12, 12₁, 12₂ may adjust powers of its DSL tones and assign data traffic to the DSL tones of individual DSL subscriber lines 16₁-16_{N} according to the method 40 so that the total information throughput to the set of DSL subscribers is increased. In some embodiments, the determinations at the step 44 may be made so that the local TELCO nodes 12, 12₁, 12₂ can increase DSL data throughputs by exploiting crosstalk between the DSL subscriber lines 16₁-16_{N}. For example, the DSL data traffic assignments may include using one or more DSL tones on one DSL subscriber line to carry data traffic destined for another DSL subscriber.

At the step 44, the method 40 may include determining the power levels of DSL tones in a manner that tends to increase an overall utility of the DSL system. For example, the overall utility may be defined by an objective function, OF, whose value increases as the DSL information traffic rate increases. Such an objective function, OF, sums the utilities of the individual DSL subscriber lines. The utility of the m-th DSL subscriber is often defined in terms of an information transmission rate thereon. Thus, for N DSL subscriber lines, e.g., the DSL subscriber lines 16₁-16_{N} of FIGS. 1-2, the objective function, OF, may be defined as:
OF=Σ^{N}ₙ₌₁Uₙ(Σ^{F}_{f=1}Rⁿ_{f}). (1)
Here, Uₙ(Rⁿ₁+ . . . +Rⁿ_{F}) is the utility of the DSL subscriber line “n”. Each “Rⁿ_{f}” measures an information transmission rate over the DSL tone “f” of the DSL subscriber line “n” in one direction, e.g., from a TELCO node to a DSL subscriber. Thus, in the argument of Uₙ(Σ^{F}_{f=1}Rⁿ_{f}), the sum measures an aggregate information transmission rate on the DSL subscriber line “n” in one direction. The step 44 may be performed in a manner that either substantially increases or approximately maximizes the selected objective function, OF, e.g., either locally or globally over the operating space of the DSL system.

In eq. (1), the Rⁿ_{f}'s are elements of an N×F dimensional matrix, R, whose elements may indicate an obtainable information transmission rate over the DSL tones of the individual DSL subscriber lines. For example, each element, Rⁿ_{f}, may have the form:

$${R}_{f}^{n} = log ( 1 + \frac{{d}_{f}^{n} \cdot {P}_{f}^{n}}{( {\sum }_{m \neq n} {C}^{n , m} ( f ) \cdot {P}_{f}^{m} ) + {N}_{f}^{n}} ) . \qquad ( 2 )$$

In eq. (2), P is the N×F matrix of transmission powers for DSL tones and DSL subscriber lines. That is, P^{q}_{f} is the power transmitted over the DSL tone “f” on the DSL subscriber line “q”. In eq. (2), N is the matrix of received noise powers. That is, N^{q}_{f} is the noise power received in the channel of the DSL tone “f” by the receiver directly connected to the DSL subscriber line “q”. In eq. (2), d is the matrix of the direct power gains. That is, dⁿ_{f} is the direct power gain for signals transmitted to a receiver over the DSL tone “f” of the DSL subscriber line “n”. Finally, C(f) is the per-channel, power crosstalk matrix. The element C^{n,m}(f) is the ratio of the crosstalk power on a DSL tone “f” of DSL subscriber line “n” over the power transmitted to the DSL tone “f” of the DSL subscriber line “m”, wherein the crosstalk in the DSL subscriber line “n” is caused by the transmission of power to the DSL tone “f” in the DSL subscriber line “m”.

In eq. (1), the utility functions of individual DSL subscriber lines, i.e., the Uₙ's, may have various forms, and the forms may differ for different ones of the subscriber lines. Typically, a DSL subscriber line's utility function may grow linearly over a range of values of the line's aggregate information transmission rate. Often, a DSL subscriber line's utility function has a convex-up form. A DSL subscriber line's utility function may be non-decreasing with the aggregate information transmission rate, but may saturate at large values of the aggregate information transmission rate thereon or increase more slowly at high values of said rate. For a DSL subscriber line “n” whose aggregate information transmission rate is Rⁿ, i.e., Rⁿ=Rⁿ₁+ . . . +Rⁿ_{F}. examples of convex single-line utility functions, Uₙ(Rⁿ), include:

$$\begin{matrix}{U}_{n} ( {R}^{n} ) = \{ \begin{matrix}a \cdot {R}^{n} / c for 0 \leq {R}^{n} \leq c \\ a for {R}^{n} > c\end{matrix} , & ( 3 a ) \\ {U}_{n} ( {R}^{n} ) = \{ \begin{matrix}a \cdot [ 1 - {( 1 - {R}^{n} / c )}^{2} ] for 0 \leq {R}^{n} \leq c \\ a for {R}^{n} > c\end{matrix} , & ( 3 b ) \\ {U}_{n} ( {R}^{n} ) = a \cdot {R}^{n} / ( c + {R}^{n} ) , & ( 3 c ) \\ {U}_{n} ( {R}^{n} ) = a \cdot [ 1 - exp ( - {R}^{n} / c ) ] , and & ( 3 d ) \\ {U}_{n} ( {R}^{n} ) = a \cdot log ( 1 + c \cdot {R}^{n} ) . & ( 3 e )\end{matrix}$$

In eqs. (3a)-(3e), the constants “a” and “c” are positive numbers. The number “c” describes, e.g., a preferred rate region. For example, in eqs. (3a)-(3b), the single-line utility grows with the information transmission rate in the preferred rate region where Rⁿ<c, but does not grow outside that region where Rⁿ>c. Any of the above-listed per-line utility functions, Uₙ(Rⁿ), may be used for the utilities of the individual DSL subscriber lines in the objective function, OF, that the step 44 of the method 40 substantially increases or approximately maximizes.

In various embodiments, the single-line utility functions of eq. (1) may be selected so that the increase or maximization of the value of the resulting objective function, OF, has a desired physical meaning. In some embodiments, the value of each single-line utility function may be indicative of the revenue that a DSL service provider obtains for providing service to the corresponding DSL subscriber. For example, the constant “a” of eqs. (3a)-(3e) may be set to be a larger value for a DSL subscriber for which the DSL service costs more. Indeed, the value of “a” may be proportional to the cost of DSL service to the DSL subscribers to support several cost levels for DSL subscriber service. In such embodiments, increasing or maximizing the value of the objective function, OF, will typically tend to increase the total revenue obtained by the DSL service provider for his/her DSL subscribers. Alternatively, the value of each single-line utility function may be indicative of the quality-of-service (QoS) provided to the corresponding DSL subscriber. For example, the constant “c” of eqs. (3a)-(3e) may be set to be larger for those DSL subscribers being offered a higher QoS. The value of “c” may be set to different values so that each DSL subscriber's “c” value has a value proportional to the level of QoS offered to the DSL subscriber. In such embodiments, maximization of the objective function, OF, would tend to provide higher information transmission rates to those DSL subscribers offered higher QoSs and lower rates to those DSL subscribers offered lower QoSs.

In various embodiments, the parameters defining the single-line utility functions of eqs. (1) and/or (3a)-(3e) may also be varied during operation. Such variations could support different types of DSL service at different times. For example, such changes could support less expensive or higher QoS for DSL service offered at night or during non-peak usage hours.

In the various embodiments, the use of single-line utility functions and the maximization of eq. (1) can provide more flexibility in operating the DSL system. In particular, the determined form of the transmission power matrix, P, can be substantially different than in DSL systems that rely on individual single-line targets for information transmission rates to set the corresponding transmission power matrix elements, P.

At the step 44, the objective function, OF, is often maximized subject to multiple types of constraints. Constraints of a first type require that the power transmitted to the DSL tone of each DSL subscriber line be non-negative. Constraints of a second type require that the total powers transmitted to each DSL subscriber line be less than or equal to preset upper bounds. Constraints of the second type may be imposed by the standards-related protocols for DSL operations. Often, constraints of a third type also require that the power transmitted to the DSL tone of each DSL subscriber line be less than or equal to a preset upper bound. Due to the above described constraints, the elements of the matrix of transmission powers for DSL tones, i.e., the above matrix P, often are required to satisfy the constraints:
P^{m}_{f}≧0 for m=1, . . . ,N and f=1, . . . ,F. (4a)
Σ^{F}_{f=1}P^{m}_{f}≦P^{m} for m=1, . . . ,N. (4b)
P^{m}_{f}≦Pₘₐₓ(f) for m=1, . . . ,N and f=1, . . . ,F. (4c)
In eqs. (4b), the constant P^{m} is a preselected upper bound on the power transmitted to the DSL subscriber line “m”. In eqs. (4c), the constant Pₘₐₓ(f) is a preselected upper bound on the power transmitted to a DSL tone “f”, i.e., over any DSL subscriber line. The constraints of eqs. (4a), (4b), and/or (4c) usually define a convex region in the N×F dimensional space of the possible transmission power matrices P.

In some embodiments, the constraints imposed on the maximization of the objective function, OF, also include preset minimum levels for the powers transmitted to the individual DSL subscriber lines. An example of one such set of constraints is given by:
Σ^{F}_{f=1}P^{m}_{f}≧MP^{m} for m=1, . . . ,N. (4d)
Here, MP^{m} is a preset minimum DSL power to be transmitted to the DSL subscriber line “m”.

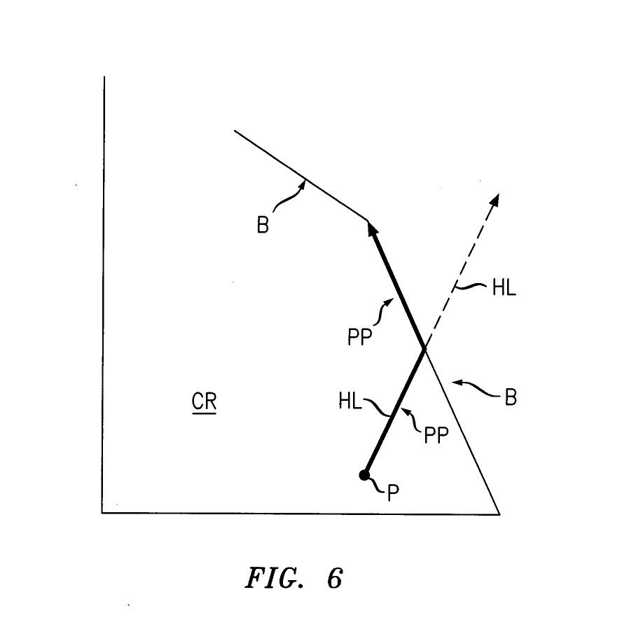

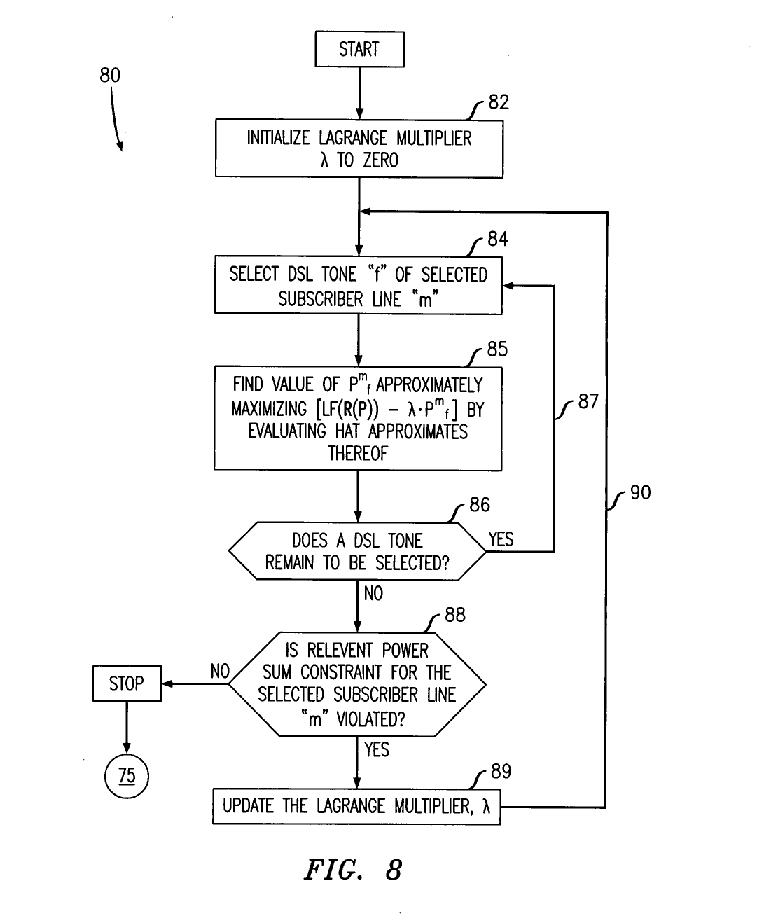

In method 40, the determination of the elements of the power transmission matrix, P, at the step 44, may be done in various manners. Typically, the step 44 involves finding a power transmission matrix, Pₘₐₓ, that approximately maximizes the objective function, OF, of eq. (1) subject to the constraints of eqs. (4a)-(4b) and possibly the constraints of eqs. (4c) and (4d). The approximate maximization may involve performing a conventional maximization algorithm that would be known to those of skill in the art. Alternatively, the approximate maximizations may involve performing the iterative method 50, as shown in FIG. 5, or the iterative method 62, as shown in FIGS. 7-8.

FIG. 5 illustrates an iterative method 50 that approximately maximizes, at each iteration, an objective function, OF, explicitly solving the constraints of eqs. (4a)-(4b).

In some embodiments, the method 50 involves maximizing an objective function that explicitly solves the constraints of eqs. (4a)-(4b). The objective function solves the constraints through a dependence on a projection operation, Π, that replaces a point, P, i.e., P=(P¹₁, . . . , P^{N}_{F}), by a projected point, Π(P). The (m, k)-th coordinate of the projected point, Π(P), is defined by:
Π^{m}ₖ(P)=[(P^{m}ₖ)⁺P^{m}]/[max{Σ^{F}ₖ₌₁(P^{m}ₖ)⁺,P^{m}}] (5a)
In eq. (5a), the sum is over DSL tones “k” of the corresponding DSL subscriber line “m”. In eq. (5a), (z)⁺ replaces a real number “z” by the maximum of “z” and “0”, and (X)⁺ replaces each component Xₖ of a real vector X by (Xₖ)⁺. In the projection operation, the inclusion of the ( )⁺-operation ensures that the N·F components of the vector Π(P) will satisfy the positivity constraints of eq. (4a). In eq. (5a), P^{m} is the preselected upper bound on the power transmitted to the DSL subscriber line “m”, i.e., the power sum constraint of eq. (4b) on the power transmitted to the DSL subscriber line “m”. From eq. (5a), the projected point Π(P) is equal to (P)⁺ if (P)⁺ satisfies the sum constraints of eq. (4b). Otherwise, the projection operation Π(P) typically moves the point (P)⁺ to the boundary of the convex region of eqs. (4b) or within said region. Thus, the projection, Π, projects any point, P, in an F·N dimensional real space to a point in the convex region of eqs. (4a)-(4b).

In alternate embodiments, the method 50 involves maximizing an objective function that explicitly solves the constraints of eqs. (4a)-(4c). Again, the objective function solves the constraints through a dependence on a projection operation, Π, that replaces a point, P, i.e., P=(P¹₁, . . . , P^{N}_{F}), by a projected point, Π(P). Again, the (m, k)-th coordinate of the projected point, Π(P), is defined by:
Π^{m}ₖ(P)=[(P^{m}ₖ)⁺P^{m}]/[max{Σ^{F}ₖ₌₁(P^{m}ₖ)⁺,P^{m}}] (5b)
But, in eq. (5b), the ( )⁺ operation is modified with respect to its definition in eq. (5a). In particular, (P^{m}ₖ)⁺ replaces P^{m}ₖ with 0 if P^{m}ₖ is negative and replaces P^{m}ₖ with Pₘₐₓ(k) if P^{m}ₖ>Pₘₐₓ(k). Thus, the definition of the projection operation, Π, has been altered to account for the additional constraints of eqs. (4c).

The method 50 involves maximizing functions, OF′, of the form:
OF′=OF(Π(P[n]+V[n]·t/(1−t))). (6)
Here, the function, Π, is the projection operation of eq. (5a) or (5b) as appropriate. From eq. (6), each maximization is performed on a projection of a ½-line, Y(t), which is defined in an F·N dimensional real space. Here, the ½-line is defined by Y(t)=[P[n]+V[n]·t/(1−t)] with tε[0, 1). The F·N-dimensional matrix V[n] defines the direction of the corresponding ½-line in an F·N dimensional real space and the matrix P[n] is the stating point of the ½-line. During maximization, the objective function, OF, is always evaluated on a projected path whose points, i.e., Π(X)'s, always satisfy the constraints of eqs. (4a)-(4b).

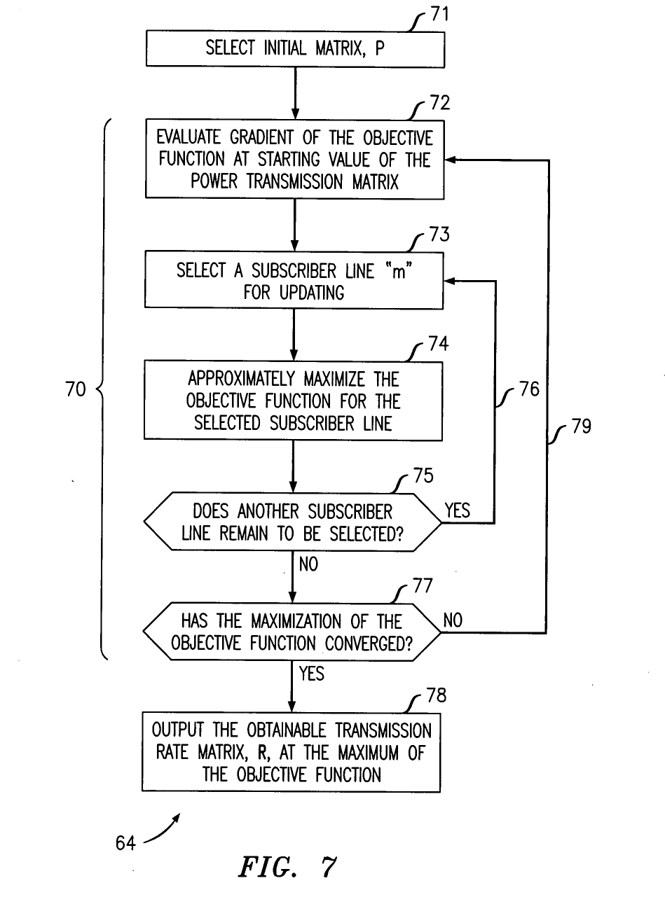

FIG. 6 schematically illustrates how the projection Π maps an exemplary ½-line (HL) into a projected path (PP) of points that solves the constraints of eqs. (4a)-(4b). The exemplary ½-line, HL, starts in the convex region (CR) where the constraints of eqs. (4a)-(4b) are satisfied, e.g., the point P[0] is in the convex region, CR. The projected path, PP, corresponding to the starting portion of the ½-line, HL, also lies in the convex region, CR. Indeed, this portion of the projected path, PP, lies on the same ½-line, HL. The ½-line, HL, also intersects a boundary (B) of the convex region, CR, so that a portion of the ½-line, HL, lies outside the convex region, CR, where the constraints of eqs. (4a)-(4b) are satisfied. At the boundary, B, the projected path, PP, can develop a corner so that it remains on the boundary, B, of the convex region, CR, while the corresponding portion of the ½-line, HL, leaves the convex region, CR.

The projection Π may cause the projected paths for other ½-lines to stop at points on the boundary of the convex region in which eqs. (4a)-(4b) are satisfied (not shown in FIG. 6).

FIG. 5 illustrates the iterative method 50 in which the objective function, OF, is approximately maximized by a hill climbing algorithm.

The method 50 includes selecting a starting power transmission matrix, P[0], for the first iteration of the maximization (step 52). The starting matrix, P[0], is located inside the convex region where eqs. (4a)-(4b) are satisfied.

At the n-th iteration, the method 50 includes determining a search direction, V[n−1] based on the starting power transmission matrix P[n−1] for the n-th iteration (step 54). The search direction, V[n−1], may be determined from the value of the objective function, OF(P[n−1]), and/or the value of its gradient, ∇_{X}OF(X)|_{X=P[n-1]}. In some embodiments, the search direction, V[n−1], is fixed by the value of the gradient of the objective function, OF, at the starting power transmission matrix, P[n−1]. That is, V[n−1] may be equal to ∇_{X}OF(X)|_{X=P[n-1]}. Then, the iterative method 50 produces a gradient ascent maximization scheme. In other embodiments, the search direction, V[n−1], may be defined from the value of the gradient of the objective function, OF, at the starting power transmission matrix P[n−1] and the value of one or more previous search direction(s), e.g., V[n−2]. Then, the iterative method 50 can produce a conjugate gradient maximization scheme.

The method 50 includes finding a power transmission matrix at which the objective function, OF, has an increased value or an approximately maximal value (step 56). At the n-th iteration, the finding step 56 involves searching said value of the objective function along a projection of a ½-line whose starting point is the n-th iteration's starting power transmission matrix, P[n−1]. The finding step 56 involves searching for an increased value or approximately maximal value of the function OF(Π(Y(t))) along a ½-line, Y(t), wherein Y(t) satisfies Y(t)=[P[n−1]+V[n−1]·t/(1−t)] with tε[0, 1). At the n-th iteration, the finding step 56 will be referred to as finding the relevant value of the power transmission matrix at a value of parameter “t” that with be referred to as “tₙ₋₁”.

Some search algorithms, e.g., conjugate gradient algorithms, may involve checking multiple search directions at some points. For example, if the original search is done along a path that the projection, Π, projects to a single boundary point, another search along a different direction may be needed. Thus, the method 50 includes determining whether to search along supplemental direction(es), e.g., for the selected starting power transmission matrix (step 58). If such a search is needed, the step 58 includes looping back 59 to the step 56 to perform the needed search along the supplemental direction(es) and thereby possibly find other value(s) of the power transmission matrix that increase or approximately maximize the value of the objective function, OF.

The method 50 includes determining whether the value of the objective function, OF, which was found at the step 56, has been sufficiently increased or maximized with respect to the value of the objective function, OF, that was found at the last iteration (step 60).

If the value of the power transmission matrix found at the finding step 56 is determined to not have sufficiently increased or maximized the objective function, OF, then, the method 50 includes selecting the projected power transmission matrix found at the n-th iteration of the step 56, i.e., Π(Y(tₙ₋₁)), as the starting power transmission matrix P[n] for the next iteration, i.e., P[n]=Π(Y(tₙ₋₁)) (step 62). Then, the method 56 includes looping back to the step 54 to perform the (n+1)-th iteration based on this newly selected starting power transmission matrix.

If the value of the power transmission matrix, as found at the step 56, is determined to have sufficiently increased or maximized the objective function, OF, then, the method 50 includes outputting the found value of the projected power transmission matrix, i.e., Π(Y(tₙ₋₁)), as the power transmission matrix that sufficiently increases or approximately maximizes the objective function, OF (step 63).

FIGS. 7-8 illustrate an alternate iterative method 64 for approximately maximizing a selected objective function, OF, based on hat approximants thereto. The iterative method 64 includes nested outer and an inner loops 70, 80 of steps.

FIG. 7 illustrates the iterative method 64 for approximately maximizing the selected objective function, OF. The method 64 includes selecting an initial power transmission matrix, P[0] (step 71). The initial power transmission matrix, P[0], satisfies the constraints to be imposed on DLS power transmissions over the set DSL subscriber lines, e.g., as imposed by eqs. (4a)-(4b) or eqs. (4a)-(4c). The initial power transmission matrix, P[0], defines the initial form for the obtainable information transmission rate matrix, R[0], e.g., according to eqs. (2). After selection of the initial form of the power transmission matrices P[0], the method 64 involves executing the outer loop 70.

At each iteration of the outer loop 70, the method 64 includes evaluating the gradient of the objective function, OF, at the starting value of the power transmission matrix for the iteration being performed (step 72). At the n-th iteration, the gradient is evaluated at P=P[n−1], i.e., is evaluated at R=R(P [n−1]). That is, P[n−1] and R(P [n−1]) are the starting values of the power transmission matrix and the obtainable information transmission rate matrix at the n-th iteration. At the first iteration, the gradient is evaluated at P=P[0] or R=R(P [0]). The gradient provides a linearized estimate to the objective function, OF, i.e., at the point R=R[n−1]. The linearized estimate is defined by:
OF(R)≈OF(R[n−1])⁺(R−R[n−1])·∂_{R}OF(R)|_{R=R[n-1]}. (7a)

Next, the method 64 includes selecting a DSL subscriber line for updating in the outer loop 70 (step 73). The updating of the selected DSL subscriber line will involve finding values of the elements of the power transmission matrix on the selected line that approximately maximize the objective function, OF.

Next, the method 64 involves finding an approximate maximum of the objective function, OF, with respect to the transmission powers of the DSL tones on the selected line based on hat approximants to the objective function, OF (step 74). The approximate maximization is also based on the linearized estimate of the objective function, OF(R), e.g., as defined in eq. (7a). For example, each approximate maximization may use an object, LF(R), defined by:
LF(R)=R·{∂_{R}OF(R)}|_{R=R[n-1]}. (7b)
LF(R) describes how the linearized estimate to the objective function, OF(R), will vary with the value of the obtainable information transmission rate matrix, R. Performance of the step 74 involves executing the inner loop 80.

The method 64 may include then, determining whether one or more other DSL subscriber lines remain to be selected at the step 73 (step 75). If one or more such DSL subscriber lines remain for selection, the method 64 includes looping back 76 to the step 73-75 to select one such remaining DSL subscriber line. If another such DSL subscriber line does not remain, the method 64 includes determining whether the maximization of the objective function, OF, has converged (77). The adequacy of such convergence may be decided by comparing the estimate to the maximum of the objective function, OF, of the present iteration of the outer loop 70 to the estimate of the previous iteration of the outer loop 70. Small differences in these compared values of the objective function, OF, may indicate adequate convergence at the step 77. Alternately, the adequacy of such convergence may be decided by comparing the values of the power transmission matrix at the maximum of the objective function, OF, in the present iteration of the outer loop 70 to the value of the power transmission matrix at the maximum of the objective function, OF, in the previous iteration of the outer loop 70. Small differences in these compared power transmission matrices may indicate adequate convergence at the step 77. If the maximization has adequately converged, the method 64 includes outputting the value of the obtainable transmission rate matrix, R, at the maximum of the objective function, OF (step 78). If the maximization has not adequately converged, the method 64 includes looping back 79 to the step 72. Then, the next execution of the outer loop 70 will use the value of the power transmission matrix, P, at the maximum of the objective function, OF, i.e., as found in this iteration, for the starting value of the power transmission matrix therein.

FIG. 8 illustrates the inner loop 80 of the method 64. At each iteration, the inner loop 80 involves separately maximizing the linearized approximation of the objective function, OF, as shown in eq. (7a) or eq. (7b), over the transmitted DSL tone powers of the DSL subscriber line selected at the step 73. Below, that DSL subscriber line will be referred to as the DSL subscriber line “m”. Thus, each iteration involves performing separate maximizations over the elements, P^{m}_{f}, of the power transmission matrix, P, for the presently selected DSL subscriber line. Each of these maximizations of the objective function, OF, with respect to the individual P^{m}_{f}'s may be simplified by using hat approximants to the linearized estimates for the objective function, OF(P). The hat approximants provide global upper bounds to the objective function, OF(P), on the intervals over which maxima of the objective function, OF(P), are being searched.

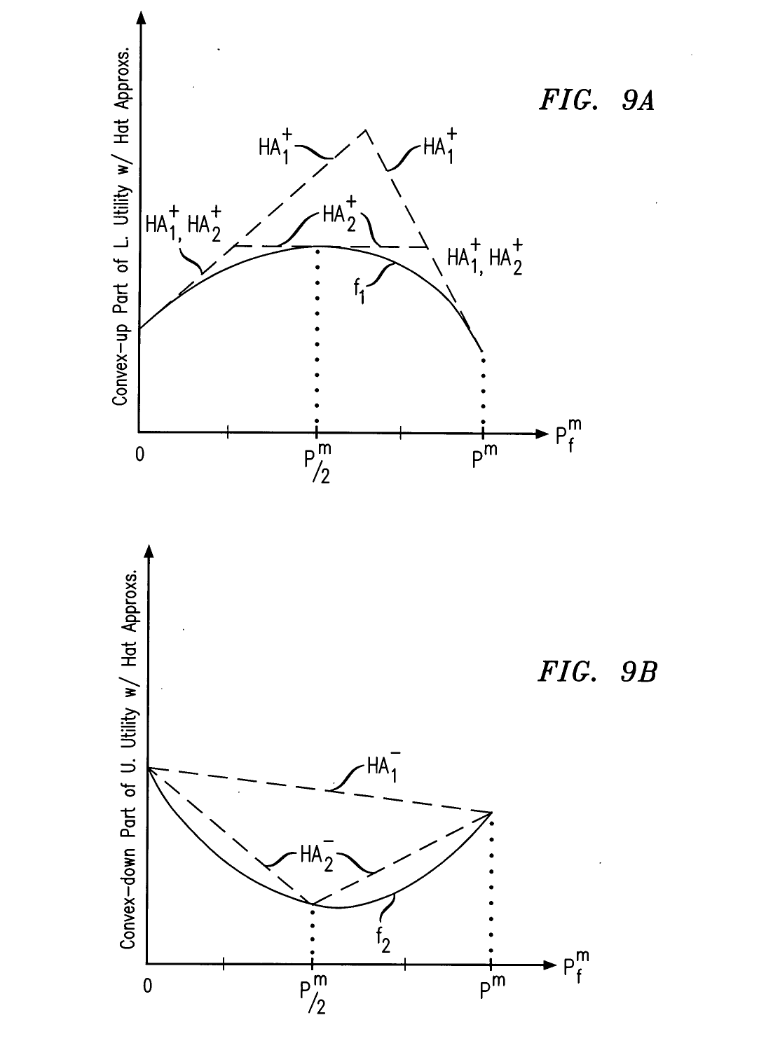

Illustrations of simple hat approximants to a convex-up function f₁(P^{m}_{f}) and to a concave-up function f₂(P^{m}_{f}) are shown in FIGS. 9A and 9B, respectively. For a convex-up function, a hat approximant over an interval is formed by selecting a set of points on the interval, forming tangent lines to the function at each of the selected points, and taking a union of segments of the tangent lines to form a hat-shaped, piecewise-linear approximation to the convex-up function over the interval. In FIG. 9A, a first hat approximant to the exemplary convex-up function, fᵢ(P^{m}_{f}), is indicated by dashed line segments HA⁺₁. This first hat approximant is formed by a hat-shaped object formed of segments of two tangent lines to the curve, f₁(P^{m}_{f}), at the points P^{m}_{f}=0, P^{m}. In FIG. 9A, a second hat approximant to the exemplary convex-up function, f₁(P^{m}_{f}), is indicated by dashed line segments HA⁺₂. This second hat approximant is formed by a hat-shaped object formed of segments of three tangent lines to the curve, fᵢ(P^{m}_{f}), at the points P^{m}_{f}=0, P^{m}/2, P^{m}. For a concave-up function, a hat approximant over an interval is formed by selecting points on the interval, forming secants or cords to the function between neighboring ones of the selected points, and taking the union of the secants or cords to form a cup-shaped, piecewise-linear approximation to the concave-up function over the interval. In FIG. 9B, the first hat approximant to the exemplary concave-up function, f₂(P^{m}_{f}), is indicated by the dashed line segment HA⁻₁. This first approximant is formed by the secant or cord between points on the concave-up function, f₂(P^{m}_{f}), at P^{m}_{f}=0, P^{m}. In FIG. 9B, a second hat approximant to the function, f₁(P^{m}_{f}), is formed by is indicated by the dashed line segments HA⁻₂. This approximant is formed by two secants or cords between points on the curve for the concave-up function, f₂(P^{m}_{f}), at P^{m}_{f}=0, P^{m}/2, P^{m}. The precision of a hat approximation may often be increased by selecting a denser set of points on the interval of the approximation and then, defining a new hat approximant over the denser set of points.

Each element of the obtainable information transmission rate, R, of eq. (2) is a convex-up or concave-up function of the P^{m}_{f}'s therein. In particular, the obtainable information transmission rate R^{m}_{f} is a convex-up function of the transmission power P^{m}_{f} and, the remaining obtainable information transmission rates Rⁿ_{f}, i.e., for n≠m, are concave-up functions of the same transmission power, P^{m}_{f}. Since these elements have such simple forms, the function of eq. (7b), which describes the variation of the objective function, OF, with either the elements of the power transmission matrix, P, or the elements obtainable transmission information rate, R, may be approximated by a sum of hat approximants.

FIG. 8 illustrates the inner loop 80 of the iterative method 64 that evaluates an approximate maximum of the objective function, OF, over the elements of the power transmission matrix for a selected DSL subscriber line. The DSL subscriber line is selected at the step 73 of the outer loop 70 and will be referred to below as the DSL subscriber line “m” for simplicity.

The method 64 starts the inner loop 80 by initializing a Lagrange multiplier, λ, to zero (step 82). In the inner loop 80, the Lagrange multiplier will be used to make the maximization conform to the constraints of eq. (4b) as necessary.

At the start of each iteration or a first loop in the inner loop 80, the method 64 includes selecting a DSL tone, which will be referred to as the tome “f” for simplicity (step 84). Each iteration will determine the value of the element, P^{m}_{f}, of the power transmission that approximately maximizes the linearized estimate to the objective function, OF, or a modification thereof to include a Lagrange multiplier. Here, the DSL tone “f” will vary for separate iterations of this part of the inner loop 80.

At each such iteration, the method 64 includes finding the value of the appropriate element of the power transmission matrix, e.g., the element P^{m}_{f}, which approximately maximizes the function [LF(R(P))−λ·P^{m}_{f}] (step 85). Finding the value of said element involves evaluating hat approximates of the function [LF(R(P))−λ·P^{m}_{f}] over the interval defined by the constraints of eqs. (4a) and possible as further limited by eqs. (4c). Here, LF(R(P)) may be, e.g., the function defined by above eqs. (7b) and (2). In LF(R(P)), each component of the power transmission matrix, P, has its starting value from the outer loop 70 except those components that have already been considered at earlier performances of the step 85. Execution of the step 85 will find a new value of the element under consideration, e.g., P^{m}_{f}. That new value approximately maximizes the objective function, OF, with respect to this element of the matrix, P. Future performances of the step 85 will replace the value of the element P^{m}_{f} by its value as found in the latest relevant performance of the step 85.

Next, the method 64 determines whether, at least, one DSL tone remains to be selected at the step 84 for the DSL subscriber line “m” (step 86). If such a DSL tone remains, the method 64 includes looping back 87 to the step 84 to execute steps 84-85 for such a new DSL tone.

If no such DSL tone remains, the method 64 includes determining whether there is a significant violation of the relevant power sum constraint for the DSL subscriber line “m” (step 88). If λ=0, the relevant power sum constraint is the inequality of eq. (4b) for the selected DSL subscriber line. If λ≠0, the relevant power constraint at the step 88 will be the equality Σ^{F}_{f=1}P^{m}_{f}=P^{m}. If the relevant power sum constraint is not violated by a significant amount, the execution of the inner loop 80 stops and control returns to the outer loop 70. Then, values of the elements of the power transmission matrix for the DSL subscriber line “m”, which approximately maximize the objective function, have been found.

For λ=0, a significant violation of the sum constraint of eq. (4b) implies that the maximum from the step 85 is not a maximum of the objective function at an acceptable value of the power transmission matrix. In such cases, an acceptable maximum of the objective function should typically occur when the equality Σ^{F}_{f=1}P^{m}_{f}=P^{m} is satisfied. Thus, if the violation of the constraint of eq. (4b) has a significant magnitude, the method 64 includes updating the Lagrange multiplier, λ, i.e., as shown in step 89, and then, looping back 90 to perform the step 84 for the new value of the Lagrange multiplier, λ. In such loop backs, the update of the Lagrange multiplier, λ, involves, e.g., increasing the value of λ if [Σ^{F}_{f=1}P^{m}_{f}−P^{m}] is positive and decreasing the value of λ if [Σ^{F}_{f=1}P^{m}_{f}−P^{m}] is negative. At each update, the amount of the increase or decrease to the Lagrange multiplier, λ, can be fixed according to a conventional schemes for finding roots, i.e., roots of [Σ^{F}_{f=1}P^{m}_{f}−P^{m}] considered as a function of k. In such loop backs, the hat approximants for [LF(R(P))−λ·P^{m}_{f}] may be simply related to those for LF(R(P)), i.e., for the λ=0 case. For that reason, such repeats of the step 85, i.e., for λ≠0, may be performed more rapidly if the hat approximants of [LF(R(P))−λ·P^{m}_{f}] are evaluated based on stored values of the evaluated hat approximants for LF(R(P)).

In some embodiments of the methods 40, 50, 64 of FIGS. 4, 5, 7 and 8, it may be desirable to change the power transmission matrix in a temporally gradual manner. In particular, it may be desirable to ensure that update-induced changes to signal-to-interference-plus-noise ratios (SINRs) on DSL subscriber lines be limited in magnitude. To produce such a behavior, additional history dependent constraints may be imposed on the elements of the power transmission matrix, P, e.g., constraints based on previous values of SINRs. Alternately, updated values of the power transmission matrix may be determined by searching for points where the value of the total objective function is larger than its previous value without necessarily being actual maxima thereof.

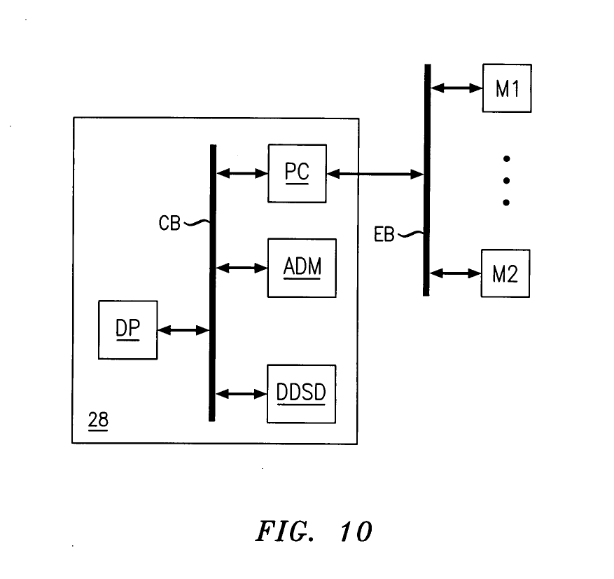

FIG. 10 illustrates an exemplary controller 28 configured to perform the method 40 of FIG. 4, the method 50 of FIG. 5, and/or the method 64 of FIGS. 7-8. For example, the controller 28 may be an embodiment of the controller of the TELCO nodes 12, 12₂ in FIGS. 1 and 2. The controller 28 includes a port controller (PC), a communications bus (CB), a digital processor (DP), an active digital memory (ADM), and a digital data storage device (DDSD). The port controller, PC, is configured to control communications between the controller 28 and DSL modems M1, . . . , MN, e.g., TELCO DSL modems 24₁, . . . , 24_{N} of FIGS. 1-2. For example, the port controller PC may connect the internal communications bus CB to an external bus (EB) to which the DSL modems M1, . . . , MN are also connected. The communications bus CB supports communications between the port controller PC, the digital processor DP, the active digital memory ADM, and the digital data storage device DDSD. The digital processor DP is capable of executing instructions of one or more processor-executable programs, wherein the one or more programs are stored in the active digital memory ADM and/or the digital data storage device DDSD. For example, these programs may include instructions for executing the steps of methods 40, 50, 64 of FIGS. 4, 5, 7, and 8. The active digital memory ADM may also store data useful to the execution of said instructions, e.g., measured values of the matrices C(f) and N, measured and determined values of the matrix P, and traffic rates over the DSL tones of the various DSL subscriber lines. The active digital memory, ADM may also store data for transmission to DSL subscribers via the TELCO DSL modems M1, . . . , MN or data received by the TELCO DSL modems M1, . . . , MN. The digital data storage device DDSD may include a storage device such as a magnetic or optical disk and an associated disk reader and/or a hard drive. In particular, the digital data storage device DDSD may store digital processor-executable programs of instructions for executing one or more of methods 40, 50, 64 of FIGS. 4, 5, 7, and 8.

From the disclosure, drawings, and claims, other embodiments of the invention will be apparent to those skilled in the art.

What we claim is:

1. An apparatus, comprising:
a plurality of DSL modems, each DSL modem being configured to be connected to a corresponding DSL subscriber line; and
wherein a first of the DSL modems is configured to transmit a data stream to a DSL subscriber via inter-line cross-talk between the one of the DSL subscriber lines connected to the first of the DSL modems and the one of the DSL subscriber lines connected to a second of the DSL modems.

2. The apparatus of claim 1,
wherein the second of the DSL modems is connected by its corresponding DSL subscriber line to the DSL subscriber; and
wherein the first of the DSL modems is configured to transmit data to the DSL subscriber on a different DSL tone than the second of the DSL modems.

3. The apparatus of claim 1, further comprising
the one of the DSL subscriber lines connected to the first of the DSL modems, a portion of the one of the DSL subscriber lines connected to the first of the DSL modems being in a binder; and
the one of the DSL subscriber lines connected to the second of the DSL modems, a portion of the one of the DSL subscriber lines connected to the second of the DSL modems being in the same binder.

4. The apparatus of claim 1, further comprising:
a controller connected to configure the DSL modems; and
wherein one of the first and second DSL modems is located in a first local central office and another of the first and second DSL modems is located in either a second local central office or a remote terminal.

5. A method of transmitting data from TELCO DSL modems to DSL subscribers, comprising:
transmitting data from a first of the DSL modems to one of the DSL subscribers via a DSL subscriber line connected to a second of the DSL modems.

6. The method of claim 5, further comprising:
transmitting data from the second of the DSL modems to the one of the DSL subscribers via the DSL subscriber line, the DSL subscriber line connecting the one of the DSL subscribers to the second of the DSL modems.

7. The method of claim 6, wherein the one of acts of transmitting data is performed in a first local central office and the other of the acts of transmitting is performed in either a second local central office or a remote terminal.

8. The method of claim 6, wherein the act of transmitting data from the first of the DSL modems includes transmitting the data on a different DSL tone than the act of transmitting data from the second of the DSL modems.

9. The method of claim 5, further comprising:
transmitting data from the first of the DSL modems to another of the DSL subscribers via another DSL subscriber line, the another DSL subscriber line connecting the first of the DSL modems to the another of the DSL subscribers.

10. The method of claim 5, wherein the act of transmitting data includes transferring the data to the DSL subscriber line via inter-line crosstalk between DSL subscriber lines.

11. A method for operating a set of DSL subscriber lines, comprising:
updating entries of a power transmission matrix for the set of DSL subscriber lines such that a sum of utilities of the DSL subscriber lines has a larger value when the per-tone transmission powers of the DSL subscriber lines have the determined values.

12. The method of claim 11, further comprising:
resetting transmission powers of DSL tones on the set of DSL subscriber lines to values corresponding to the updated entries.

13. The method of claim 11, wherein the updating includes finding an approximate maximum of the total utility by evaluating hat approximants thereof.

14. The method of claim 11, wherein the updating includes an finding an approximate maximum of the total utility by performing a maximization of the total utility along a path.

15. The method of claim 11, wherein the sum of utilities is indicative of a revenue obtainable for DSL service.

16. The method of claim 11, wherein the sum of utilities is indicative of a quality of service.
